(19) United States
(12) Patent Application Publication
(10) Pub. No.: US 2026/0187408 A1
(43) Pub. Date: Jul. 2, 2026

(54) METHOD FOR LABELING TIME SERIES DATA RELATING TO ONE OR MORE MACHINES

(71) Applicant: ASML Netherlands B.V., Veldhoven (NL)

(72) Inventors: Dimitra GKOROU, Eindhoven (NL); Anjan Prasad GANTAPARA, Veldhoven (NL); Alexander YPMA, Veldhoven (NL); Yakup AYDIN, Bunnik (NL)

(73) Assignee: ASML Netherlands B.V., Veldhoven (NL)

(21) Appl. No.: 19/130,989

(22) PCT Filed: Nov. 6, 2023
(86) PCT No.: PCT/EP2023/080874

§ 371 Date: May 19, 2025

(30) Foreign Application Priority Data
Dec. 2, 2022 (EP) 22211052.0

(51) Int. Cl. G06N 3/042; G06N 3/0895

(52) U.S. Cl. CPC G06N 3/042; G06N 3/0895

(57) ABSTRACT

Disclosed is a method for labeling time series data relating to one or more machines. The method comprises obtaining said time series data; segmenting said time series data to obtain a plurality of patterns grouped according to pattern similarity; labeling a subset of said plurality of patterns to obtain a labeled subset of patterns, the remaining patterns of the plurality of patterns comprising unlabeled 5 patterns; defining a graph structure over said patterns, said graph structure describing similarity between the patterns; and classifying and/or labeling the unlabeled patterns to obtain labeled patterns using the graph structure and the labeled subset of patterns.

### CROSS-REFERENCE TO RELATED APPLICATIONS

This application claims priority of EP Application Serial No. 22211052.0 which was filed on Dec. 2, 2022 and which is incorporated herein in its entirety by reference.

### FIELD OF THE INVENTION

The present invention relates to methods and apparatus usable, for example, in the manufacture of devices by lithographic techniques, and to methods of manufacturing devices using lithographic techniques. The invention relates more particularly to failure detection for such devices.

### BACKGROUND ART

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g. including part of a die, one die, or several dies) on a substrate (e.g., a silicon wafer). Transfer of the pattern is typically via imaging onto a layer of radiation-sensitive material (resist) provided on the substrate. In general, a single substrate will contain a network of adjacent target portions that are successively patterned. These target portions are commonly referred to as “fields”.

In the manufacture of complex devices, typically many lithographic patterning steps are performed, thereby forming functional features in successive layers on the substrate. A critical aspect of performance of the lithographic apparatus is therefore the ability to place the applied pattern correctly and accurately in relation to features laid down (by the same apparatus or a different lithographic apparatus) in previous layers. For this purpose, the substrate is provided with one or more sets of alignment marks. Each mark is a structure whose position can be measured at a later time using a position sensor, typically an optical position sensor. The lithographic apparatus includes one or more alignment sensors by which positions of marks on a substrate can be measured accurately. Different types of marks and different types of alignment sensors are known from different manufacturers and different products of the same manufacturer.

In other applications, metrology sensors are used for measuring exposed structures on a substrate (either in resist and/or after etch). A fast and non-invasive form of specialized inspection tool is a scatterometer in which a beam of radiation is directed onto a target on the surface of the substrate and properties of the scattered or reflected beam are measured. Examples of known scatterometers include angle-resolved scatterometers of the type described in US2006033921A1 and US2010201963A1. In addition to measurement of feature shapes by reconstruction, diffraction based overlay can be measured using such apparatus, as described in published patent application US2006066855A1. Diffraction-based overlay metrology using dark-field imaging of the diffraction orders enables overlay measurements on smaller targets. Examples of dark field imaging metrology can be found in international patent applications WO 2009/078708 and WO 2009/106279 which documents are hereby incorporated by reference in their entirety. Further developments of the technique have been described in published patent publications US20110027704A, US20110043791A, US2011102753A1, US20120044470A, US20120123581A, US20130258310A, US20130271740A and WO2013178422A1. These targets can be smaller than the illumination spot and may be surrounded by product structures on a wafer. Multiple gratings can be measured in one image, using a composite grating target. The contents of all these applications are also incorporated herein by reference.

Hardware components in a machine such as a lithographic apparatus or other apparatus used in the manufacture of integrated circuits (ICs) may degrade over time. The health status of these hardware components therefore needs to be monitored, so as to prevent unscheduled down-time and/or non-yielding/non-functional ICs. Such apparatuses are extremely complex, comprising many modules and a very large number of sensors, and therefore provide very large amounts of data (e.g., such as time-series data). Analyzing such a large volume of data to estimate a health status is difficult. Because of this, supervised machine learning techniques are sometimes employed to analyze the data and estimate a health status (or more generally an apparatus status).

It would be desirable to improve on such supervised machine learning based system state or health-state estimation methods.

### SUMMARY OF THE INVENTION

The invention in a first aspect provides a method for labeling time series data relating to one or more machines is disclosed, the method comprising: obtaining said time series data; segmenting said time series data to obtain a plurality of patterns grouped according to pattern similarity; labeling a subset of said plurality of patterns to obtain a labeled subset of patterns, the remaining patterns of the plurality of patterns comprising unlabeled patterns; defining a graph structure over said patterns, said graph structure describing similarity between the patterns; and classifying and/or labeling the unlabeled patterns to obtain labeled patterns using the graph structure and the labeled subset of patterns.

Also disclosed is a computer program being operable to perform the method of the first aspect.

The above and other aspects of the invention will be understood from a consideration of the examples described below.

### BRIEF DESCRIPTION OF THE DRAWINGS

Embodiments of the invention will now be described, by way of example only, with reference to the accompanying drawings, in which:

FIG. 1 depicts a lithographic apparatus;

FIG. 2 illustrates schematically measurement and exposure processes in the apparatus of FIG. 1;

FIG. 3 is a plot of a sensor signal against time, showing different patterns, each representative of a respective apparatus status or health status;

FIG. 4 is a flow diagram of a prior art method for determining an apparatus status or health status of a machine;

FIG. 5 is a flow diagram of a method for determining an apparatus status or health status of a machine according to an embodiment;

FIG. 6 (a) is a flow diagram of step 525 of FIG. 5) according to an embodiment, and FIG. 6 (b) is an exemplary similarity graph according to an embodiment

FIG. 7 is a flow diagram for rule generation according to an embodiment; and

FIG. 8 is a flow diagram for generating labeled data for training other machine learning algorithms according to an embodiment.

### DETAILED DESCRIPTION OF EMBODIMENTS

Before describing embodiments of the invention in detail, it is instructive to present an example environment in which embodiments of the present invention may be implemented.

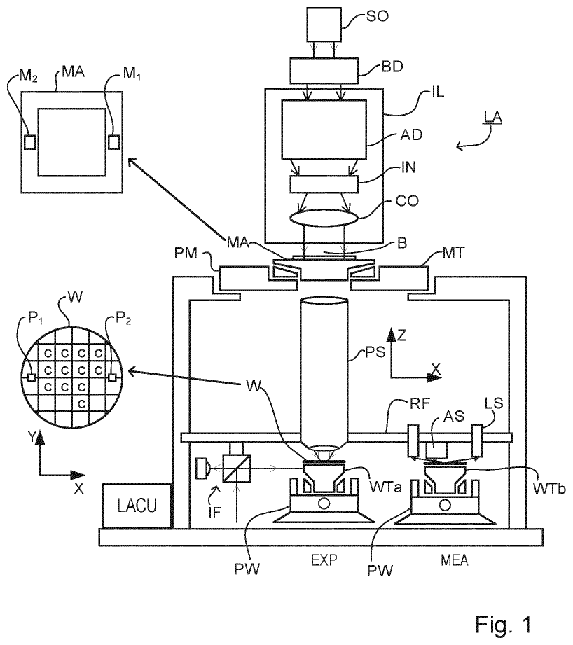

FIG. 1 schematically depicts a lithographic apparatus LA. The apparatus includes an illumination system (illuminator) IL configured to condition a radiation beam B (e.g., UV radiation or DUV radiation), a patterning device support or support structure (e.g., a mask table) MT constructed to support a patterning device (e.g., a mask) MA and connected to a first positioner PM configured to accurately position the patterning device in accordance with certain parameters; two substrate tables (e.g., a wafer table) WTa and WTb each constructed to hold a substrate (e.g., a resist coated wafer) W and each connected to a second positioner PW configured to accurately position the substrate in accordance with certain parameters; and a projection system (e.g., a refractive projection lens system) PS configured to project a pattern imparted to the radiation beam B by patterning device MA onto a target portion C (e.g., including one or more dies) of the substrate W. A reference frame RF connects the various components, and serves as a reference for setting and measuring positions of the patterning device and substrate and of features on them.

The illumination system may include various types of optical components, such as refractive, reflective, magnetic, electromagnetic, electrostatic or other types of optical components, or any combination thereof, for directing, shaping, or controlling radiation.

The patterning device support MT holds the patterning device in a manner that depends on the orientation of the patterning device, the design of the lithographic apparatus, and other conditions, such as for example whether or not the patterning device is held in a vacuum environment. The patterning device support can use mechanical, vacuum, electrostatic or other clamping techniques to hold the patterning device. The patterning device support MT may be a frame or a table, for example, which may be fixed or movable as required. The patterning device support may ensure that the patterning device is at a desired position, for example with respect to the projection system.

The term “patterning device” used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

As here depicted, the apparatus is of a transmissive type (e.g., employing a transmissive patterning device). Alternatively, the apparatus may be of a reflective type (e.g., employing a programmable mirror array of a type as referred to above, or employing a reflective mask). Examples of patterning devices include masks, programmable mirror arrays, and programmable LCD panels. Any use of the terms “reticle” or “mask” herein may be considered synonymous with the more general term “patterning device.” The term “patterning device” can also be interpreted as referring to a device storing in digital form pattern information for use in controlling such a programmable patterning device.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system”.

The lithographic apparatus may also be of a type wherein at least a portion of the substrate may be covered by a liquid having a relatively high refractive index, e.g., water, so as to fill a space between the projection system and the substrate. An immersion liquid may also be applied to other spaces in the lithographic apparatus, for example, between the mask and the projection system. Immersion techniques are well known in the art for increasing the numerical aperture of projection systems.

In operation, the illuminator IL receives a radiation beam from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD including, for example, suitable directing mirrors and/or a beam expander. In other cases the source may be an integral part of the lithographic apparatus, for example when the source is a mercury lamp. The source SO and the illuminator IL, together with the beam delivery system BD if required, may be referred to as a radiation system.

The illuminator IL may for example include an adjuster AD for adjusting the angular intensity distribution of the radiation beam, an integrator IN and a condenser CO. The illuminator may be used to condition the radiation beam, to have a desired uniformity and intensity distribution in its cross section.

The radiation beam B is incident on the patterning device MA, which is held on the patterning device support MT, and is patterned by the patterning device. Having traversed the patterning device (e.g., mask) MA, the radiation beam B passes through the projection system PS, which focuses the beam onto a target portion C of the substrate W. With the aid of the second positioner PW and position sensor IF (e.g., an interferometric device, linear encoder, 2-D encoder or capacitive sensor), the substrate table WTa or WTb can be moved accurately, e.g., so as to position different target portions C in the path of the radiation beam B. Similarly, the first positioner PM and another position sensor (which is not explicitly depicted in FIG. 1) can be used to accurately position the patterning device (e.g., mask) MA with respect to the path of the radiation beam B, e.g., after mechanical retrieval from a mask library, or during a scan.

Patterning device (e.g., mask) MA and substrate W may be aligned using mask alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the patterning device (e.g., mask) MA, the mask alignment marks may be located between the dies. Small alignment marks may also be included within dies, in amongst the device features, in which case it is desirable that the markers be as small as possible and not require any different imaging or process conditions than adjacent features. The alignment system, which detects the alignment markers is described further below.

The depicted apparatus could be used in a variety of modes. In a scan mode, the patterning device support (e.g., mask table) MT and the substrate table WT are scanned synchronously while a pattern imparted to the radiation beam is projected onto a target portion C (i.e., a single dynamic exposure). The speed and direction of the substrate table WT relative to the patterning device support (e.g., mask table) MT may be determined by the (de-) magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion. Other types of lithographic apparatus and modes of operation are possible, as is well-known in the art. For example, a step mode is known. In so-called “maskless” lithography, a programmable patterning device is held stationary but with a changing pattern, and the substrate table WT is moved or scanned.

Combinations and/or variations on the above described modes of use or entirely different modes of use may also be employed.

Lithographic apparatus LA is of a so-called dual stage type which has two substrate tables WTa, WTb and two stations—an exposure station EXP and a measurement station MEA—between which the substrate tables can be exchanged. While one substrate on one substrate table is being exposed at the exposure station, another substrate can be loaded onto the other substrate table at the measurement station and various preparatory steps carried out. This enables a substantial increase in the throughput of the apparatus. The preparatory steps may include mapping the surface height contours of the substrate using a level sensor LS and measuring the position of alignment markers on the substrate using an alignment sensor AS. If the position sensor IF is not capable of measuring the position of the substrate table while it is at the measurement station as well as at the exposure station, a second position sensor may be provided to enable the positions of the substrate table to be tracked at both stations, relative to reference frame RF. Other arrangements are known and usable instead of the dual-stage arrangement shown. For example, other lithographic apparatuses are known in which a substrate table and a measurement table are provided. These are docked together when performing preparatory measurements, and then undocked while the substrate table undergoes exposure.

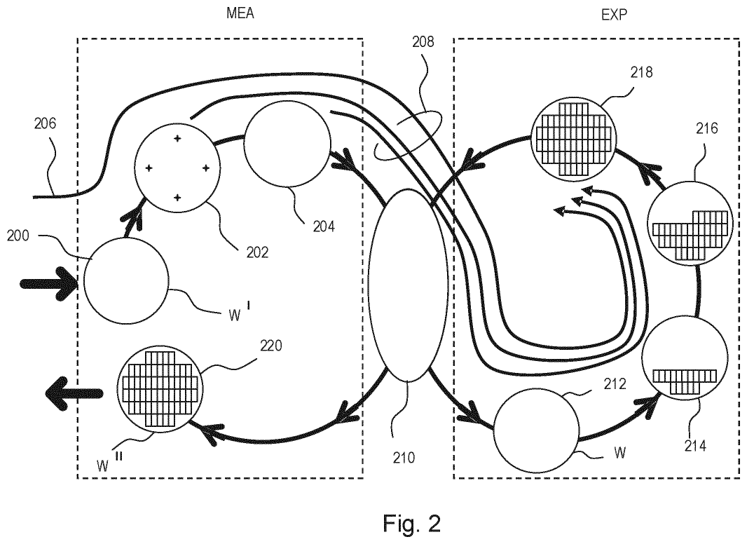

FIG. 2 illustrates the steps to expose target portions (e.g. dies) on a substrate W in the dual stage apparatus of FIG. 1. On the left hand side within a dotted box are steps performed at a measurement station MEA, while the right hand side shows steps performed at the exposure station EXP. From time to time, one of the substrate tables WTa, WTb will be at the exposure station, while the other is at the measurement station, as described above. For the purposes of this description, it is assumed that a substrate W has already been loaded into the exposure station. At step 200, a new substrate W′ is loaded to the apparatus by a mechanism not shown. These two substrates are processed in parallel in order to increase the throughput of the lithographic apparatus.

Referring initially to the newly-loaded substrate W′, this may be a previously unprocessed substrate, prepared with a new photo resist for first time exposure in the apparatus. In general, however, the lithography process described will be merely one step in a series of exposure and processing steps, so that substrate W′ has been through this apparatus and/or other lithography apparatuses, several times already, and may have subsequent processes to undergo as well. Particularly for the problem of improving overlay performance, the task is to ensure that new patterns are applied in exactly the correct position on a substrate that has already been subjected to one or more cycles of patterning and processing. These processing steps progressively introduce distortions in the substrate that must be measured and corrected for, to achieve satisfactory overlay performance.

The previous and/or subsequent patterning step may be performed in other lithography apparatuses, as just mentioned, and may even be performed in different types of lithography apparatus. For example, some layers in the device manufacturing process which are very demanding in parameters such as resolution and overlay may be performed in a more advanced lithography tool than other layers that are less demanding. Therefore some layers may be exposed in an immersion type lithography tool, while others are exposed in a ‘dry’ tool. Some layers may be exposed in a tool working at DUV wavelengths, while others are exposed using EUV wavelength radiation.

At 202, alignment measurements using the substrate marks P1 etc. and image sensors (not shown) are used to measure and record alignment of the substrate relative to substrate table WTa/WTb. In addition, several alignment marks across the substrate W′ will be measured using alignment sensor AS. These measurements are used in one embodiment to establish a “wafer grid”, which maps very accurately the distribution of marks across the substrate, including any distortion relative to a nominal rectangular grid.

At step 204, a map of wafer height (Z) against X-Y position is measured also using the level sensor LS. Conventionally, the height map is used only to achieve accurate focusing of the exposed pattern. It may be used for other purposes in addition.

When substrate W′ was loaded, recipe data 206 were received, defining the exposures to be performed, and also properties of the wafer and the patterns previously made and to be made upon it. To these recipe data are added the measurements of wafer position, wafer grid and height map that were made at 202, 204, so that a complete set of recipe and measurement data 208 can be passed to the exposure station EXP. The measurements of alignment data for example comprise X and Y positions of alignment targets formed in a fixed or nominally fixed relationship to the product patterns that are the product of the lithographic process. These alignment data, taken just before exposure, are used to generate an alignment model with parameters that fit the model to the data. These parameters and the alignment model will be used during the exposure operation to correct positions of patterns applied in the current lithographic step. The model in use interpolates positional deviations between the measured positions. A conventional alignment model might comprise four, five or six parameters, together defining translation, rotation and scaling of the ‘ideal’ grid, in different dimensions. Advanced models are known that use more parameters.

At 210, wafers W′ and W are swapped, so that the measured substrate W′ becomes the substrate W entering the exposure station EXP. In the example apparatus of FIG. 1, this swapping is performed by exchanging the supports WTa and WTb within the apparatus, so that the substrates W, W′ remain accurately clamped and positioned on those supports, to preserve relative alignment between the substrate tables and substrates themselves. Accordingly, once the tables have been swapped, determining the relative position between projection system PS and substrate table WTb (formerly WTa) is all that is necessary to make use of the measurement information 202, 204 for the substrate W (formerly W′) in control of the exposure steps. At step 212, reticle alignment is performed using the mask alignment marks M1, M2. In steps 214, 216, 218, scanning motions and radiation pulses are applied at successive target locations across the substrate W, in order to complete the exposure of a number of patterns.

By using the alignment data and height map obtained at the measuring station in the performance of the exposure steps, these patterns are accurately aligned with respect to the desired locations, and, in particular, with respect to features previously laid down on the same substrate. The exposed substrate, now labeled W″ is unloaded from the apparatus at step 220, to undergo etching or other processes, in accordance with the exposed pattern.

The skilled person will know that the above description is a simplified overview of a number of very detailed steps involved in one example of a real manufacturing situation. For example rather than measuring alignment in a single pass, often there will be separate phases of coarse and fine measurement, using the same or different marks. The coarse and/or fine alignment measurement steps can be performed before or after the height measurement, or interleaved.

In a lithography system, an important issue which has a significant impact on system up-time and is the ability to quickly and efficiently detect and/or diagnose events or trends (e.g., apparatus status, health status and/or fault events) which might be indicative of irregular or abnormal behavior. However, such systems are very complex, comprising a number of different modules (e.g., including inter alia projection optics module, wafer stage module, reticle stage module, reticle masking module) each of which generate large amounts of data. Complex issues, involving multiple modules may be a particular challenge to diagnose due to a lack of data for the failure event.

The performance of hardware components in a machine, such as a lithographic apparatus (scanner) or other machine used in IC manufacture, degrades over time due to wear and/or ageing. If degraded components are not replaced, refurbished or in some way maintained, the machine functionality will not remain within specification, which will result in yield loss (ICs which are not functional). Thus, maintenance of degrading hardware components in a machine is of great or critical importance, impacting its availability and yield capacity.

Sensor measurements (sensor signals) are typically used as indications of the health status of hardware components. Typically, such sensor measurements comprise multiple signals and as such, are high dimensional. Sensor measurements show different patterns corresponding to the health status (i.e., an apparatus status) of the hardware component. Health status or apparatus status, for example, may be categorized in two or more categories of interest; for example a three category system may categorize the health status as either “healthy/good”, “degrading” and “unhealthy/not good”. These categories are purely exemplary and the number of categories and/or their definitions may be dependent on the use case.

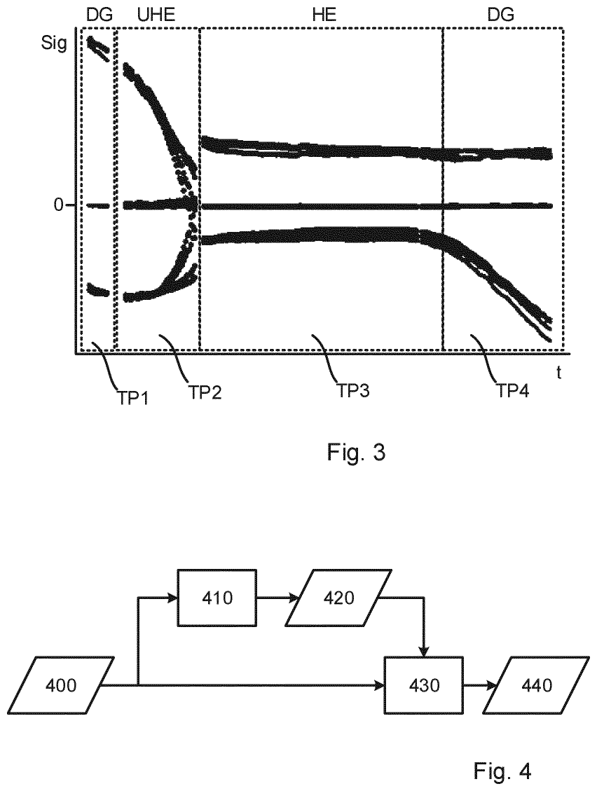

FIG. 3 is a plot of sensor signals against time illustrating an example of correspondence of signal behavior to hardware state. More specifically, the plot shows labeled sensor measurements of a machine hardware component over four distinct time periods distinguishable by the signal behavior. During a first time period TP1, the signals are indicative of degrading behavior DG of the component (i.e., the component is degrading and that a maintenance action is required shortly to refurbish or replace the component to prevent unscheduled downtime and/or poor yield). This quickly develops into unhealthy behavior UHE of the component over a second time period TP2 (i.e., being indicative that the component is badly degraded to the point where yield is being affected and that a maintenance action is required immediately). A third time period TP3 indicates a healthy status HE of the component, and as such, the transition from the second time period TP2 to the third time period TP3 may be indicative of a maintenance action having been performed to replace or refurbish the component. The final time period TP4 is a further degrading behavior DG time period, as the component again begins to degrade.

At present, two alternative methods for performing such monitoring and prediction of health status are often used. Firstly, the estimation of health status can be automated via a supervised Machine Learning (ML) method, where a classification ML model receives the high dimensional signals from sensor measurements as input and maps these to a health status (labels). The classifier is typically trained to give predictions per data point of time series without considering the time dependent nature of data. The labels for the training set may come from domain expertise, performance measurements or other sources.

FIG. 4 is a flow diagram illustrating such a prior art method. The measured sensor data, comprising unlabeled data 400, undergoes a labeling step 410 to label a (limited) subset of the measured sensor data, thereby obtaining labeled training data 420. A ML classifier 430 then classifies the remaining unlabeled data 400 based on the labeled training data 420, so as to determine a health status 440 for the unlabeled data 400 (and therefore the component(s) this data relates to).

Most supervised learning methods require a large amount of labeled data, which is typically unavailable. As domain experts typically label the sensor measurements, acquiring more labels is time consuming. In addition, many signals are ambiguous so neither an algorithm nor a domain expert can label them with confidence. Additionally, the procedure for creating training sets for ML models: sensor measurements can be noisy with several outliers and discontinuities. As a result, methods that focus on labeling data points are sensitive to this noise and propagate it to the predictions.

A second known method may comprise applying thresholds (e.g., representing one or more specifications) to each data point via heuristics. However, such thresholds can be inaccurate and unable to deal with high dimensional sensor measurements or ambiguous patterns. Also, as with the classifier method described, thresholding is susceptible to noise in the sensor measurements.

As such, in either of the two prior art methods described, the predictions are prone to inconsistencies and errors.

It is therefore proposed to process the time series data according to their patterns and define a graph structure over the patterns. The graph structure may be used in classifying the processed time series data using only limited labels and a large number of unlabeled data points. The graph structure may encode physical properties of sensor degradation via a similarity or distance function used for its construction. As such, the graph structure may describe the physical properties of the degrading hardware component. If this is not known, any similarity function may be used.

Defining a graph structure over said patterns may comprise or describe modelling pairwise relationships between the patterns, e.g., in terms of a similarity metric.

As such, a method for labeling time series data relating to one or more machines is disclosed, the method comprising: obtaining said time series data; segmenting said time series data to obtain a plurality of patterns grouped according to pattern similarity; labeling a subset of said plurality of patterns to obtain a labeled subset of patterns, the remaining patterns of the plurality of patterns comprising unlabeled patterns; defining a graph structure over said patterns, said graph structure describing similarity between the patterns; and classifying and/or labeling the unlabeled patterns to obtain labeled patterns using the graph structure and the labeled subset of patterns.

While present approaches ignore temporal dependencies within the time series data and provide only predictions per data point, the proposed methods exploit the patterns emerging in the temporal neighborhood of a data point (e.g., to address noise) and provides predictions within this context. Additionally, the physical property that similarly shaped patterns should result in similar machine health states may be imposed by encoding this property in a similarity graph of patterns. This graph may be used to impose smoothness on the estimation of labels over the graph structure and it can work with very few labeled instances. Additionally, the prior art methods cannot model the manifestation of physical aspects of the degradation measured by the sensor, such as for example, a change of drift rate in a few signals or a change of variation in the signals.

In outline, the measured sensor data, comprising unlabeled input time series data from each machine, is segmented into clusters or time series patterns of similarly evolving behavior. The similarity between the patterns may then be encoded in a graph. Labels may be applied to a small subset of patterns using domain expertise or any other source of knowledge e.g., performance measurements. These labels may be propagated to the full dataset using semi-supervised algorithms which take into account the graph. A human expert (or any other knowledge source) can support the semi-supervised model for improved accuracy. In this manner, a good accuracy can be obtained with only a limited number of labels in an active learning loop.

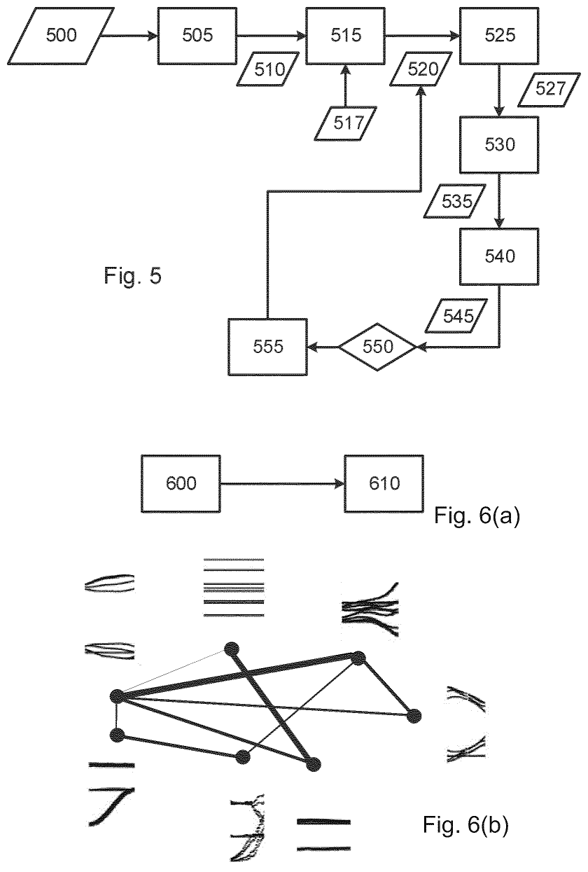

FIG. 5 is a flow diagram illustrating the proposed method in more detail. At step 505, unlabeled input time series data 500 (e.g., from one or more machines) is segmented or partitioned into a plurality of patterns 510 of similar behavior. Typically, degradation manifests in sensor measurements with respective different drift patterns. The drifts can be incremental, linear, recurring, a sudden change (jump) or gradual drifting behavior. The number of data points may vary between these patterns.

Segmentation step 500 may use any suitable time series segmentation algorithm. The segmentation can be performed in any suitable domain; e.g., in either the time, frequency or spatial domain. Examples of suitable algorithms include inter alia Gaussian segmentation, Hidden Markov Models, Neural Networks for time series segmentation, t-distributed stochastic neighbor embedding (t-SNE) or principal component analysis (PCA) with clustering.

A specific example of a segmentation algorithm may comprise performing the segmentation spatially with agglomerative clustering and dimensionality reduction as defined by Uniform Manifold Approximation (UMAP). UMAP is a graph-based dimensionality reduction algorithm using applied Riemannian geometry for estimating low-dimensional embeddings. The advantage of such an implementation is that it works very well with a limited amount of data, and addresses the curse of dimensionality (sensor measurements may have more than 100 dimensions). UMAP is described, for example, in “Parametric UMAP Embeddings for Representation and Semisupervised Learning”, by Sainburg, Tim and McInnes, Leland and Gentner, Timothy Q, in Neural Computation, vol 33, pages=2881-2907, 2021, which is incorporated herein by reference.

UMAP estimates the nearest neighbor similarities around a data point by defining a region or circle around each data point. Each point's circle comprises its nearest neighbors. For example, the similarity (e.g., a value for a similarity metric) may be quantified for a particular data point (e.g., data point A) by defining a circle centered on data point A and comprising data point A's nearest neighbors. The size of each circle may be defined by the proximity of a data point's neighbors, e.g., such that each circle for each respective data point comprises a set (same) number of neighbors. Other methods for defining the circle size is possible, as the skilled person will appreciate. A similarity metric value or similarity score may be estimated for each of the neighbors within a circle based on distance from the center (i.e., from data point A in the specific example). In an embodiment, this similarity score may be determined to decrease exponentially from the center to the periphery of the circle.

Such an approach may comprise a time series segmentation with UMAP applied per machine. Applying UMAP per machine in this manner provides a low dimensional representation which preserves the similarity of data points in the high dimensional space. Surprisingly, without any temporal information, the resulting representation respects also the temporal vicinity of two data points. This may be explained with the aggressive exponential decay on the similarity of nearest neighbors in UMAP as described above. In hardware degradation signals, data points with temporal vicinity typically have more similar measurements than data points which are further away in time. That similarity is exaggerated with the exponential decay of similarity. This means that temporal vicinity is equivalent to spatial vicinity because the signals are smoothly evolved. An agglomerative clustering may then be applied to separate the data into time series patterns. In an embodiment, agglomerative clustering with single linkage may be used due to the elongated shape of the derived clusters. In order to decide the number of appropriate clusters, a Silhouette score may be used, for example.

A labeling step 515 may comprise applying rules and/or annotations 517 to a (e.g., small) subset of the patterns 510. For example, depending on the maturity of domain expertise for a particular hardware component, domain experts may provide labels as annotations on the time series data or as rules. To provide a specific illustrative example of a rule: it may be defined that a health status of a particular component is bad and the component should be replaced when a signal drift rate is higher than a threshold rate. Other rules may indicate the nature of aging effects; for example, it may be imposed that a sequence of states has to follow three or more sequential categories, such as: “green” (OK) to “orange” (degrading) to “red” (bad). In other scenarios, performance measurements can be used to indicate labels. For example, machine matching overlay measurements can be used to indicate the health of an alignment sensor. The output of this step is a labeled subset of patterns 520.

The labeling step 515 may comprise, for example, applying the same rules or labels to all the points of a pattern (cluster). There are several methods to do this. One method comprises considering a respective representative object or point from each pattern and aggregating their labels to estimate one label for the full pattern. Such an aggregation may comprise, for example, a majority of votes within an ensemble scheme. In a specific example, the medoid of each cluster may be defined as the representative object or point.

At step 525, a graph-based semi-supervised learning (SSL) on the data patterns 510 may be performed, using the partially labeled data 520. Semi-supervised learning is a family of algorithms which exploit a small amount of labeled data and a large amount of unlabeled data to jointly learn the structure of a dataset and optimize the supervised objective e.g., classifying time series patterns. These algorithms result in more accurate predictions when sufficient unlabeled data is available because they take advantage of the structure of the unlabeled data when estimating the classification labels. A Graph provides additional domain information on the machine learning algorithms. An aim of graph-based SSL methods is to impose graph constraints to the loss function, and therefore to guarantee or impose smoothness over the graph.

The SSL step 525 may comprise the sub-steps illustrated by FIG. 6 (a). At step 600, a similarity graph (i.e., a graph indicative of pattern similarity in accordance with a similarity metric) is constructed over the patterns 510, e.g., to describe the relationships between the identified patterns 510 in terms of their similarity. A simplified example of a graph is illustrated in FIG. 6 (b), where a node indicates a pattern (a respective exemplary pattern is shown beside each node) and an edge between two nodes indicates similarity. The thickness of an edge represents the magnitude of similarity. While each of the nodes relates to a different identified pattern, only a small or relatively small subset of these patterns will be initially labeled (e.g., in step 515). At step 610, these initial labels are propagated to all patterns in accordance with the graph.

For this SSL step 525 there are several alternative approaches which may be used. The best approach for a given scenario may be dependent on the characteristics and/or the size of data. Some example possible approaches will be described in greater detail later in this description.

Returning to FIG. 5, at step 530, a respective health status 535 is predicted per pattern based on the labeled data 527 obtained from SSL step 525. The method may end at this point, or optionally continue through the following steps to improve learning.

At an active learning step 540, utility scores 545 may be estimated per pattern. The utility is a function which assigns a utility score to each pattern indicating its informativeness; e.g., the estimated effect of the labeling of this pattern on the performance of the classification. The utility score of each pattern may comprise a combination of different metrics for model uncertainty and diversity of patterns. Uncertainty may be margin-based (e.g., the difference between the probabilities of two most probable classes), entropy-based or based on the probability of the most probable class. Diversity or representativeness of a pattern can be based on any definition of distance or similarity among patterns. Graph theoretic centrality metrics such as degree, betweenness and eigenvector centrality could be also used to indicate diversity and representativeness. The appropriate combination of these quantities may result in hyperparameters, learned with hyperparameter tuning technics such as cross validation or reinforcement learning.

At step 550, the machines having the most informative patterns may be selected for annotation (step 555) based on the utility scores 545. The number of selected machines can be defined based on thresholds or expert time constraints or on the difference of the utility scores (e.g., in an elbow-like manner, where an elbow methods is a heuristic used in clustering for determining the number of clusters in a dataset. Such elbow methods are known and will not be described further).

At step 555, a domain expert may annotate the selected machines. This inserts new domain knowledge as the domain experts can use additional information for their labeling such as interactions with user, overlay data or yield data. This information typically would not be available in the application of the proposed method due to confidentiality issues. However, this method is able to use this information in a systematic way. This additional annotation can be added to the partially labeled data 520 used in subsequent iterations of the method.

More example detail for SSL Step 525 will now be described. To construct the similarity graph, firstly the distance or similarity between each pair of patterns should be determined. This can be achieved according to any suitable similarity or distance metric.

Such a similarity metric may define the similarity between the patterns based on knowledge of degradation physics of the component being monitored. For example, if for a first sensor, drift rates of the measured signals define aging degradation, in the construction of the graph a distance metric may be used that captures the drift rates e.g., correlation/covariance/cosine etc. Some specific similarity metrics and algorithms will now be described, which may be used as appropriate.

For example an algorithm which can handle time series of different lengths may be used. Such algorithms may include, for example, dynamic time warping (DTW), a shape matching algorithm which finds the best mapping between two time series with the minimized cumulative alignment distance. Using DTW, different lengths of time series are naturally handled. As an alternative, the similarity metric may be time warp edit distance (TWED) which is accurate but slow computationally.

Traditional similarity functions or metrics for time series of the same length may also be used, such as correlation, cross-correlation, euclidean distance, cosine, edit distance (Levehnstein). These can be used by computing any of these metrics on selected representative points such as centroids, medoids or percentiles. This solution is fast but less accurate.

Other similarity metrics may comprise frequency-based similarity metrics; e.g., a similarity function which captures dynamic characteristics of the time series patterns. For example, similarity (or distance) based on Fourier and Wavelet decompositions, spectral density etc. can be used. A further example may comprise a compression based similarity metric (e.g., based on information theory).

The similarity metric may include domain expectation on what is considered to be similarly behaving patterns for a particular state such as a failing sensor. For example, if drift rate is important for detecting a failing sensor then angular distances such as correlation or cosine similarity may be used. If the shape of two patterns is important then Dynamic Time Warping may be used.

Once similarity between patterns is determined, a similarity graph may be constructed, where the graph encodes the structure of the whole set of time series patterns. A graph may be represented by an adjacency matrix W. Each node i represents a time series segment (pattern) and each entry W_{i,j} denotes the weight of an edge connecting node i to another node j. The weight W_{i,j} can be any function of similarity/distance between the patterns i and j: for example, an exponential, Gaussian or quadratic kernel provided it decays to zero as the distance between the two nodes increases.

The Graph-based semi-supervised classification (label propagation step 610) can be performed using a method which may be chosen depending on the amount of available data. A first such method may comprise a label propagation over the graph with potentially additional sparsity constraints (e.g. sparse dictionary learning or low-rank models). Label propagation propagates label information of the few available labeled samples to the unlabeled samples to estimate their labels using the similarity graph. These methods assume that closer patterns have similar labels. Larger edge weights allow labels to be propagated more easily. Graph neural networks or any other suitable method may also be used.

In more detail, based on the similarity graph, a label propagation method may construct an affinity matrix W and its corresponding Laplacian S as S=D^{-1/2} W D^{-1/2} where D is the diagonal matrix of W. The loss function of label propagation may be Local and Global Consistency. This loss function may comprise two objectives: 1) a smoothness constraint imposing consistency on labels of neighboring data points and 2) a fitting constraint imposing that any change from the initial label assignment should be minimized and/or kept small in the final classification.

Additional sparsity constraints on the graph construction may be imposed, such as sparse dictionary and low rank methods. Label propagation is probabilistic and therefore, for each pattern, all different labels can be seen as a distribution over the labels. Label propagation is a transductive process meaning that it cannot cope with out-of-sample instances.

Another label propagation method may comprise generating graph-based pseudo-labels for a neural network. Such generation of pseudo labels may be similar to clustering. This is also a transductive setting. Graph structure may be used as a clustering method to obtain pseudo-labels of the unlabeled data points, which together with the labeled samples, are used to pre-train a neural network. The neural network can then be fine-tuned using only the available labeled data points.

As an alternative, to label propagation, neural networks may be used for semi-supervised learning if sufficient data is available. As the sensor measurements are typically high dimensional signals with more than 100 dimensions, the graph structure can be used as regularization to improve generalization to new data. The graph embedding may be written as a loss function, such that it can be viewed as hidden layers of a neural network. In this case, the neural networks may be regularized on top of the classification loss function [symbol] (cross-entropy), with an additional loss [symbol] predicting the graph context:

$$= {labeled}_{} + λ {unlabeled}_{}$$

Where λ is a hyperparameter and [symbol] may be any meaningful transformation of the Laplacian S of the similarity graph computed in constructing the similarity graph (e.g., as described above) such as the L2-norm, or the loss function of the graph embeddings i.e., a minimization between the distributions of distances in the high dimensional and low dimensional space. For example, UMAP could be used for the computation of the graph embedding. In this context UMAP similarity estimations are interpreted as probabilities with pᵢⱼ denoting the probability that two nodes I and j are connected in the high dimensional space and qᵢⱼ are connected in the low dimensional space. The computation of UMAP results in a loss function [symbol] that can be optimized with gradient descent:

$${ℒ}_{unlabeled} = {\sum }_{i \neq j} {p}_{i j} log ( \frac{{p}_{i j}}{{q}_{i j}} ) + ( 1 - {p}_{i j} ) log ( \frac{1 - {p}_{i j}}{1 - {q}_{i j}} )$$

In contrast to the above label propagation methods, this method is inductive, meaning that it can generalize to out of sample datapoints. The neural network can be either an autoencoder, CNN, or a simple feed-forward network. This method is also closely related to multi-task autoencoders where an autoencoder is trained to optimize both reconstruction error and a similarity of data points in the original space.

As an extension to the main concepts disclosed above, these concepts may be used as a tool to learn and/or update domain knowledge in the form of rules. Unlabeled patterns are those which domain experts do not know how to relate to a particular state of a hardware component. In other words, rules by domain experts cannot cover the full database of patterns and some patterns remain unlabeled. The methods disclosed herein can be used to generate new rules.

In order to estimate a label for an unlabeled pattern, the above-described classifier uses labels of similar patterns as defined by its corresponding graph. Experiments with different definitions of similarity/distance can help domain experts to define rules on which aspects of the signal is important e.g.: drift rate, shape, variation. For example, if using angular distance provides the best classification accuracy, then the rules should be defined on the drift rate. The estimated decision boundaries for the classification can be used to estimate new rules that update the thresholds of the rules. This knowledge can be used by engineers and users when maintaining and calibrating the machines. The rules are interpretable because their generation process can be described via the graph.

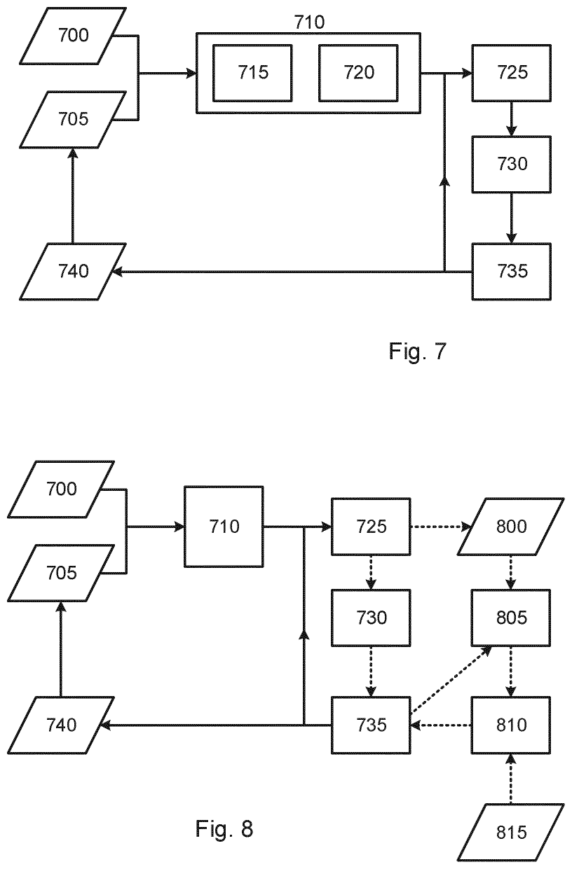

FIG. 7 is a flow diagram illustrating such an active learning method. Input time series data 700 and domain knowledge/rules 705 are fed into a rule based model 710 comprising a clustering/segmentation module 715 and a rule classifier 720. This generates a graph as has been described and a label propagation step 725 propagates labels from the labeled data to the unlabeled data based on the graph. Aspects 700 to 725 of this method may be implemented as has already been described. A learning loop is implemented comprising the label propagation step 725, an active learning step 730 (e.g., the active learning steps 540, 550 as described above) and an optional labeling step 735. In this labeling step 735, domain experts can insert their knowledge into the graph by labeling a pattern. Via the utility function (see FIG. 5: steps 540, 545), the proposed method may receive targeted input on the rules. The added domain knowledge is stored and exploited in a systematic way via the graph.

An output of the labeling step 735 are new rules 740 which may be used to update the input rules for this method, or any of the other methods disclosed herein.

The new rules result from the decision boundaries determined in the classification process, resultant from the graph encoding physical properties of the degradation process. The domain knowledge is used in the construction of a similarity graph and the labels propagated across that graph. As a result, the classification results may be used to update the domain knowledge (e.g., rules, thresholds etc.). Therefore, decision boundaries of each class are obtained from classifying on the graph; wherein the decision boundaries describe, for example, which patterns are at the edge of each class and/or closest to another class. From these patterns, drift rates (or other measures) may be computed which separate the classes, and then used to define new rules.

FIG. 8 is a flowchart describing an application of the concepts disclosed herein to creating training sets for machine learning models; e.g., to predict per point. The generated dataset may be used to train other machine learning models provide online prediction each day. While classifying patterns (a cluster of data points) instead of data points provides a more stable result, it adds a limitation in the prediction as it does not allow for classification of a single data point. To overcome this, this embodiment is proposed for producing a “golden” or reference labelled data set 800, and using a more conventional Machine Learning method 805 to classify each instance.

This method is shown as additional to the flow of FIG. 7 and therefore description of elements 700 to 740 will not be repeated. A ML model 805 receives the prelabeled data 800 output from label propagation model 725. An output of the ML model 805 may be used by an active learning step 810, in addition with production data 815. The remainder of the flow is as has been described in relation to FIG. 7.

The concepts disclosed herein result in improved models due to more consistent annotations. Domain expert annotations can be tedious and prone to errors. Thus method infers most of the time series labels and requests input from domain experts only when necessary for defining the decision boundaries. In this way, labeling is more consistent. In addition, less labeled data is needed to obtain the highest model performance.

While specific embodiments of the invention have been described above, it will be appreciated that the invention may be practiced otherwise than as described.

Although specific reference may have been made above to the use of embodiments of the invention in the context of optical lithography, it will be appreciated that the invention may be used in other applications, for example imprint lithography, and where the context allows, is not limited to optical lithography. In imprint lithography a topography in a patterning device defines the pattern created on a substrate. The topography of the patterning device may be pressed into a layer of resist supplied to the substrate whereupon the resist is cured by applying electromagnetic radiation, heat, pressure or a combination thereof. The patterning device is moved out of the resist leaving a pattern in it after the resist is cured.

The terms “radiation” and “beam” used herein encompass all types of electromagnetic radiation, including ultraviolet (UV) radiation (e.g., having a wavelength of or about 365, 355, 248, 193, 157 or 126 nm) and extreme ultra-violet (EUV) radiation (e.g., having a wavelength in the range of 1-100 nm), as well as particle beams, such as ion beams or electron beams.

The term “lens”, where the context allows, may refer to any one or combination of various types of optical components, including refractive, reflective, magnetic, electromagnetic and electrostatic optical components. Reflective components are likely to be used in an apparatus operating in the UV and/or EUV ranges.

The breadth and scope of the present invention should not be limited by any of the above-described exemplary embodiments, but should be defined only in accordance with the following claims and their equivalents.

There is provided the following clauses:
1. A method for labeling time series data relating to one or more machines, the method comprising obtaining said time series data;
segmenting said time series data to obtain a plurality of patterns grouped according to pattern similarity;
labeling a subset of said plurality of patterns to obtain a labeled subset of patterns, the remaining patterns of the plurality of patterns comprising unlabeled patterns;
defining a graph structure over said patterns, said graph structure describing similarity between the patterns; and
classifying and/or labeling the unlabeled patterns to obtain labeled patterns using the graph structure and the labeled subset of patterns.
2 A method as claimed in clause 1, wherein said time series data comprises sensor signal data from a plurality of sensors of said one or more machines.
3. A method as in clause 1 or 2, wherein said segmentation step uses a time series segmentation algorithm operable in either the time, frequency or spatial domain.
4. A method as claimed in clause 3, wherein said time series segmentation algorithm comprises at least one of: Gaussian segmentation, Hidden Markov Models, Neural Networks for time series segmentation, t-distributed stochastic neighbor embedding, principal component analysis with clustering or an agglomerative clustering and dimensionality reduction algorithm as defined by Uniform Manifold Approximation.
5. A method as claimed in any preceding clause, wherein said graph structure encodes physical properties described by the time series data.
6. A method as claimed in clause 5, wherein the physical properties encoded by said graph structure may relate to degradation of a component to which the time series data relates.
7. A method as claimed in any preceding clause, wherein said graph structure is represented by an adjacency matrix where each node represents a pattern and each entry denotes the weight of an edge connecting node, the weight comprising a function of similarity between the patterns connected by its respective edge.
8. A method as claimed in clause 7, comprising choosing a similarity metric used to quantify said similarity based on a knowledge of physics of a component to which the time series data relates.
9. A method as claimed in any preceding clause, wherein said labeling step is based on domain knowledge and/or rules.
10. A method as claimed in any preceding clause, wherein said labeling step comprises applying the same label to all the points of a respective pattern.
11. A method as claimed in any preceding clause, wherein the step of classifying and/or labeling the unlabeled patterns comprises applying a semi-supervised learning algorithm on the unlabeled patterns using the labeled subset of patterns.
12. A method as claimed in clause 11, wherein said semi-supervised learning algorithm comprises a label propagation algorithm operable to propagate the labels of said labeled subset of patterns to said unlabeled patterns in accordance with said graph structure.
13. A method as claimed in clause 12, wherein said label propagation algorithm uses a loss function which imposes consistency on labels of neighboring patterns and/or imposes that any change from the labels of said labeled subset of patterns should be minimized and/or kept small.
14. A method as claimed in clause 13, wherein said loss function is based on Local and Global Consistency
15. A method as claimed in any of clauses 12 to 14, wherein said label propagation algorithm comprises at least one sparsity constraint.
16. A method as claimed in clause 15, wherein the sparsity constraint is a sparse dictionary learning constraint or low-rank model constraint.
17. A method as claimed in any of clauses 11 to 16, wherein said semi-supervised learning algorithm generates graph-based pseudo-labels, based on said graph structure, for training a neural network.
18. A method as claimed in any of clauses 1 to 11, wherein the step of classifying and/or labeling the unlabeled patterns comprises applying a neural network to classify the unlabeled patterns based on the labeled subset of patterns, with said graph structure used as regularization.
19. A method as claimed in clause 18, wherein a graph embedding is written as a loss function viewed as hidden layers of the neural network.
20. A method as claimed in any preceding clause, wherein said defining a graph structure comprises determining a degree of said pattern similarity between each pair of said plurality of patterns according to a similarity metric.
21. A method as claimed in clause 20, wherein the determining a degree of said pattern similarity comprises using one or more of: a dynamic time warping algorithm, a time warp edit distance algorithm, a correlation algorithm, a cross-correlation algorithm, an Euclidean distance algorithm, a cosine algorithm, an edit distance algorithm, or a frequency-based similarity metric algorithm.
22. A method as claimed in any preceding clause, comprising:
determining a utility score per pattern indicative of informativeness of the pattern;
selecting one or more of said machines which have respective utility scores indicative of the most informative patterns; annotating the selected machines; and
using said annotations in determining the labeled subset of patterns.
23. A method as claimed in any preceding clause, comprising determining new rules for labeling or describing one or more of said patterns from a determination of decision boundaries obtained in said classifying step.
24. A method as claimed in any preceding clause, comprising producing a reference labelled data set, and using a machine learning model to classify individual data points of said time series data based on the reference labelled data set.
25. A method as claimed in any preceding clause, comprising using said labeled patterns to determine an apparatus status of said one or more machines.
26. A method as claimed in clause 25, wherein said apparatus status describes a health status of at least one component of said one or more machines.
27. A method as claimed in clause 25 or 26, comprising scheduling and/or performing a maintenance action on said one or more machines in accordance with said apparatus status.
28. A method as claimed in any preceding clause, comprising using said labeled patterns to determine new rules and/or thresholds for rules for labeling the time series data in said labeling step.
29. A method as claimed in any preceding clause, comprising using said labeled patterns to generate labeled training data for a machine learning model
30. A method as claimed in any preceding clause, wherein said one or more machines comprise one or more machines used in the manufacture of integrated circuits.
31. A method as claimed in any preceding clause, wherein said one or more machines comprise one or more lithographic exposure apparatuses
32. A computer program comprising program instructions operable to perform the method of any of any preceding clause, when run on a suitable apparatus.
33. A non-transient computer program carrier comprising the computer program of clause 32.
34. A processing arrangement comprising:
the non-transient computer program carrier of clause 33; and
a processor operable to run the computer program comprised on said non-transient computer program carrier.
35. A lithographic system comprising the processing arrangement of clause 34.

1-24. (canceled)

25. A computer implemented method for labeling time series data relating to one or more machines, the method comprising:
obtaining the time series data;
segmenting the time series data to obtain a plurality of patterns grouped according to pattern similarity;
labeling a subset of the plurality of patterns to obtain a labeled subset of patterns, the remaining patterns of the plurality of patterns comprising unlabeled patterns;
defining a graph structure over the patterns, the graph structure describing similarity between the patterns;
classifying and/or labeling the unlabeled patterns to obtain labeled patterns using the graph structure and the labeled subset of patterns;
determining a utility score per pattern indicative of informativeness of the pattern;
selecting one or more of the machines which have respective utility scores indicative of the most informative patterns;
annotating the selected machines;
using the annotations in determining the labeled subset of patterns; and
using the labeled patterns to determine an apparatus status of the one or more machines.

26. The method of claim 25, wherein the apparatus status describes a health status of at least one component of the one or more machines.

27. The method of claim 25, wherein the time series data comprises sensor signal data from a plurality of sensors of the one or more machines.

28. The method of claim 25, wherein the segmentation uses a time series segmentation algorithm operable in either the time, frequency or spatial domain.

29. The method of claim 28, wherein the time series segmentation algorithm comprises Gaussian segmentation, Hidden Markov Models, Neural Networks for time series segmentation, t-distributed stochastic neighbor embedding, principal component analysis with clustering or an agglomerative clustering and dimensionality reduction algorithm as defined by Uniform Manifold Approximation.

30. The method of claim 25, wherein the graph structure encodes physical properties described by the time series data.

31. The method as claimed in claim 30, wherein the physical properties encoded by the graph structure relate to degradation of a component to which the time series data relates.

32. The method of claim 25, wherein the graph structure is represented by an adjacency matrix wherein each node represents a pattern and each entry denotes the weight of an edge connecting node, the weight comprising a function of similarity between the patterns connected by its respective edge.

33. The method of claim 32, further comprising choosing a similarity metric used to quantify the similarity based on a knowledge of physics of a component to which the time series data relates.

34. The method of claim 25, wherein the labeling is based on domain knowledge and/or rules.

35. The method of claim 25, wherein the classifying and/or labeling the unlabeled patterns comprises applying a semi-supervised learning algorithm on the unlabeled patterns using the labeled subset of patterns.

36. The method of claim 35, wherein the semi-supervised learning algorithm comprises a label propagation algorithm operable to propagate the labels of the labeled subset of patterns to the unlabeled patterns in accordance with the graph structure.

37. The method of claim 35, wherein the semi-supervised learning algorithm generates graph-based pseudo-labels, based on the graph structure, for training a neural network.

38. The method of claim 25, wherein the classifying and/or labeling the unlabeled patterns comprises applying a neural network to classify the unlabeled patterns based on the labeled subset of patterns, with the graph structure used as regularization.

39. The method of claim 25, wherein the defining a graph structure comprises determining a degree of the pattern similarity between each pair of the plurality of patterns according to a similarity metric.

40. The method of claim 25, further comprising determining new rules for labeling or describing one or more of the patterns from a determination of decision boundaries obtained in the classifying.

41. The method of claim 25, further comprising scheduling and/or performing a maintenance action on the one or more machines in accordance with the apparatus status.

42. A computer program comprising:
program instructions operable to perform the method of claim 25, in response to being run on a suitable apparatus.

43. A non-transient computer program carrier comprising the computer program of claim 42.

44. A processing arrangement comprising:
the non-transient computer program carrier of claim 43; and
a processor operable to run the computer program comprised on the non-transient computer program carrier.

45. A lithographic system comprising the processing arrangement of claim 44.
